(19) United States
(12) Patent Application Publication
(10) Pub. No.: US 2024/0305942 A1
(43) Pub. Date: Sep. 12, 2024

(54) SPATIAL AUDIO CAPTURE USING PAIRS OF SYMMETRICALLY POSITIONED ACOUSTIC SENSORS ON A HEADSET FRAME

(71) Applicant: Meta Platforms Technologies, LLC, Menlo Park, CA (US)

(72) Inventors: Pablo Francisco Faundez Hoffmann, Kenmore, WA (US); Syavosh Zadissa, Bothell, WA (US); Xiaoxue Li, Mountain View, CA (US)

(21) Appl. No.: 18/120,296

(22) Filed: Mar. 10, 2023

(51) Int. Cl. H04S 7/00; H04R 1/40; H04R 3/00

(52) U.S. Cl. CPC H04S 7/301; H04R 1/406; H04R 3/005; H04R 2430/21; H04S 2420/01

(57) ABSTRACT

A headset includes multiple pairs of acoustic sensors for capturing audio of a local area surrounding the headset. Each pair of acoustic sensors includes an acoustic sensor on a side of the headset and an additional acoustic sensor on an opposite side of the headset. One pair of acoustic sensors is positioned closer to the ears of a user than other pairs of acoustic sensors. The headset determines a filter for each pair of acoustic sensors that modifies audio captured by the acoustic sensors of a pair. Application of the filter causes audio captured by the pair of acoustic sensors to have sound similar to audio captured at the user's ears. In some embodiments, audio from multiple pairs of acoustic sensors is filtered by corresponding filters then combined.

### FIELD OF THE INVENTION

This disclosure relates generally to artificial reality systems, and more specifically to binaural audio capture for artificial reality systems.

### BACKGROUND

Various artificial reality systems are capable of recording video of a local area surrounding an artificial reality system. For example, an artificial reality system includes one or more imaging devices and microphones that capture video and audio of the local area surrounding the artificial reality system. To have captured audio sound more realistic to a user when played back, binaural audio from the local area may be captured, which allows recorded content to approximate interaural cues of a user of an artificial reality system. This causes the recorded audio to sound as if it were captured by the user's ears when played back to the user. However, conventional configurations for capturing binaural audio use multiple microphones and other components positioned throughout a local area. As artificial reality systems have increasingly smaller form factors, conventional configurations for capturing binaural audio are difficult to include in an artificial reality system without increasing overall size and complexity of the artificial reality system.

### SUMMARY

Artificial reality systems often allow users to record video or audio of a local area surrounding the artificial reality system. Users may subsequently play back the recorded video or audio. However, conventional approaches to recording audio surrounding an artificial reality system result in recorded audio having acoustic properties corresponding to locations of acoustic sensors that captured the audio. As these acoustic sensors are often in different locations in the local area than the user's ears, interaural cues of audio captured by different acoustic sensors differ from interaural cues of audio captured by the user's ears. The differences in interaural cues results in audio captured by combinations of acoustic sensors sounding different than audio at the user's ears when the captured audio is played back to the user.

In various embodiments, to mitigate differences between interaural cues of audio captured by acoustic sensors and audio captured by a user's ears, a system includes one or more pairs of acoustic sensors positioned on a frame, a pair of acoustic sensors including acoustic sensors on opposite sides of the frame and aligned along an axis perpendicular to the acoustic sensors, each acoustic sensor configured to capture audio. The system also includes an audio controller configured to select one or more pairs of acoustic sensors and to obtain a filter associated with a selected pair of acoustic sensors. The audio controller generates modified audio by applying the filter to the audio captured by each acoustic sensor of the selected pair of acoustic sensors and stores the modified audio.

In some embodiments, method for mitigating differences between interaural cues of audio captured by acoustic sensors and audio captured by a user's ears includes capturing audio one or more pairs of acoustic sensors positioned on a frame, a pair of acoustic sensors including acoustic sensors on opposite sides of the frame and aligned along an axis perpendicular to the acoustic sensors. The method selects one or more pairs of acoustic sensors and obtains a filter associated with a selected pair of acoustic sensors. Modified audio is generated by applying the filter to the audio captured by each acoustic sensor of the selected pair of acoustic sensors, and the modified audio is stored

In some embodiments, a headset includes a frame and one or more display elements coupled to the frame, each display element configured to generate image light. The headset includes one or more pairs of acoustic sensors positioned on the frame, a pair of acoustic sensors including acoustic sensors on opposite sides of the frame and aligned along an axis perpendicular to the acoustic sensors, each acoustic sensor configured to capture audio. Additionally, the headset includes an audio controller including a processor and a non-transitory computer readable storage medium having instructions encoded thereon that, when executed by the processor, cause the processor to: select one or more pairs of acoustic sensors, obtain a filter associated with a selected pair of acoustic sensors, generate modified audio by applying the filter to the audio captured by each acoustic sensor of the selected pair of acoustic sensors; and store the modified audio.

### BRIEF DESCRIPTION OF THE DRAWINGS

FIG. 1 is a perspective view of a headset implemented as an eyewear device, in accordance with one or more embodiments.

FIG. 2 is a block diagram of an audio system, in accordance with one or more embodiments.

FIG. 3 is a flowchart of a method for capturing spatial audio by a headset, in accordance with one or more embodiments.

FIG. 4 is a flowchart of a method for determining a filter for a pair of acoustic sensors, in accordance with one or more embodiments.

FIG. 5 example result of application of a filter determined for a pair of acoustic sensors to a directivity pattern of an acoustic sensor of the pair, in accordance with one or more embodiments.

FIG. 6 is a process flow diagram of a method for capturing spatial audio by a headset from a pair of acoustic sensors, in accordance with one or more embodiments.

FIG. 7 is a process flow diagram of is a process flow diagram of one embodiment of a method for capturing spatial audio by a headset from multiple pairs of acoustic sensors, in accordance with one or more embodiments.

FIG. 8 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Artificial reality systems often allow users to record video or audio of a local area surrounding the artificial reality system. Users may subsequently play back the recorded video or audio. However, conventional approaches to recording audio surrounding an artificial reality system result in recorded audio having acoustic properties corresponding to locations of acoustic sensors that captured the audio. As these acoustic sensors are often in different locations in the local area than the user's ears, interaural cues of audio captured by different acoustic sensors differ from interaural cues of audio captured by the user's ears. The differences in interaural cues results in audio captured by combinations of acoustic sensors sounding different than audio at the user's ears when the captured audio is played back to the user.

To mitigate differences between acoustic characteristics of audio captured by acoustic sensors and audio captured by a user's ear, an artificial reality headset includes multiple pairs of acoustic speakers. Each pair of acoustic speakers is configured to be symmetrical about a user's head when the user wears the headset. So, each pair of acoustic speakers includes an acoustic sensor on a left side of the headset and an additional acoustic sensor on the right side of the user's headset. Additionally, the acoustic sensor of a pair and the additional acoustic sensor of a pair are horizontally aligned along an axis that is perpendicular to both the sensor and the additional acoustic sensor. In various embodiments, multiple pairs of acoustic sensors are included on the headset, with different pairs positioned so corresponding acoustic sensors have different positions relative to the user's left ear and the user right ear.

The pairs of acoustic sensors capture audio of a local area surrounding the headset. An audio controller included in the headset or coupled to the headset selects one or more of the pairs of acoustic sensors and obtains a filter associated to each of the selected pairs. A filter associated with a selected pair of acoustic sensors modifies characteristics of the audio captured by the acoustic sensors of the pair to minimize differences between the audio characteristics of the audio captured by the pair of acoustic sensors and audio captured by the user's ears. For example, a filter associated with a selected pair of acoustic sensors minimizes a difference between a directional transfer function of the user's ear and a directivity pattern of acoustic sensors of the selected pair. In another example, a filter associated with a selected pair of acoustic sensors is based on ratios of a target frequency responses of the user's ears and target frequency responses of the acoustic sensors of the pair.

The audio controller applies a filter associated with a selected pair of acoustic sensors to audio captured by the pair of acoustic sensors, generating modified audio that is stored. If the audio controller selects multiple pairs of acoustic sensors, the audio controller applies the associated filter to audio captured by each selected pair of acoustic sensors, generating multiple sets of filtered audio that each correspond to a selected pair. The audio controller combines the sets of filtered audio to generate modified audio that is stored. The modified audio reduces discrepancies between audio captured by one or more selected pairs and audio captured by the user's ears, allowing the modified audio to sound as if the audio were captured by the user's ear.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

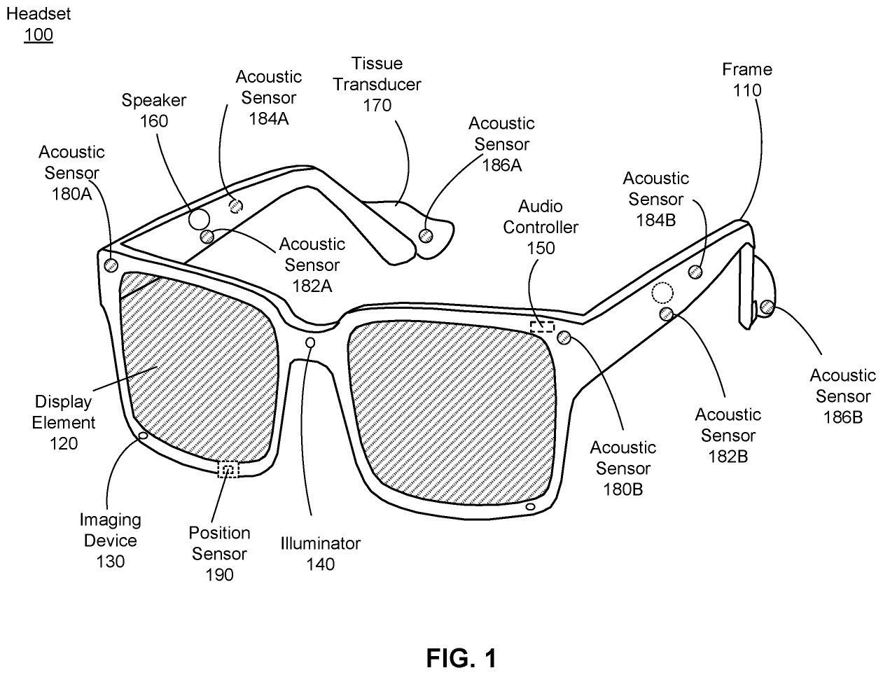

FIG. 1 is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1 illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1 shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1.

The sensor array detects sounds within the local area of the headset 100. In various embodiments, the sensor array includes pairs of acoustic sensors. In the example of FIG. 1, the headset 100 includes a first pair of acoustic sensors including acoustic sensor 180A and acoustic sensor 180B (also referred to individually and collectively using reference number 180). The headset 100 also includes a second pair of acoustic sensors including acoustic sensor 182A and acoustic sensor 182B (also referred to individually and collectively using reference number 182) and a third pair of acoustic sensors including acoustic sensor 184A and acoustic sensor 184B (also referred to individually and collectively using reference number 184). In the example of FIG. 1, the headset 100 also includes a fourth pair of acoustic sensors including acoustic sensor 186A and acoustic sensor 186B (also referred to individually and collectively using reference number 186). However, in other embodiments, the sensor array includes other numbers of pairs of acoustic sensors.

Acoustic sensors of each pair are symmetrically positioned relative to a user's head when the frame is worn by the user. A pair of acoustic sensors includes an acoustic sensor positioned on a side of the frame 110 and an additional acoustic sensor positioned on an opposite side of the frame 110 than the acoustic sensor. Additionally, an axis is perpendicular to the acoustic sensor and the additional acoustic sensor. Hence, in various embodiments, a pair of acoustic sensors includes an acoustic sensor on a left side of the frame 110 and an additional acoustic sensor on a right side of the frame 110, with the acoustic sensor horizontally aligned with the additional acoustic sensor. In the example of FIG. 1, the frame 110 includes an end piece (or temple) on a left side of the frame 110 and an additional end piece (or temple) on a right side of the frame 110. So, an acoustic sensor a pair is positioned on the end piece on the left side of the frame 110 and an additional acoustic sensor of the pair is positioned on the additional end piece (or temple) on the right side of the frame 110, with the acoustic sensor horizontally aligned with the additional acoustic sensor along an axis perpendicular to the acoustic sensor and the additional acoustic sensor.

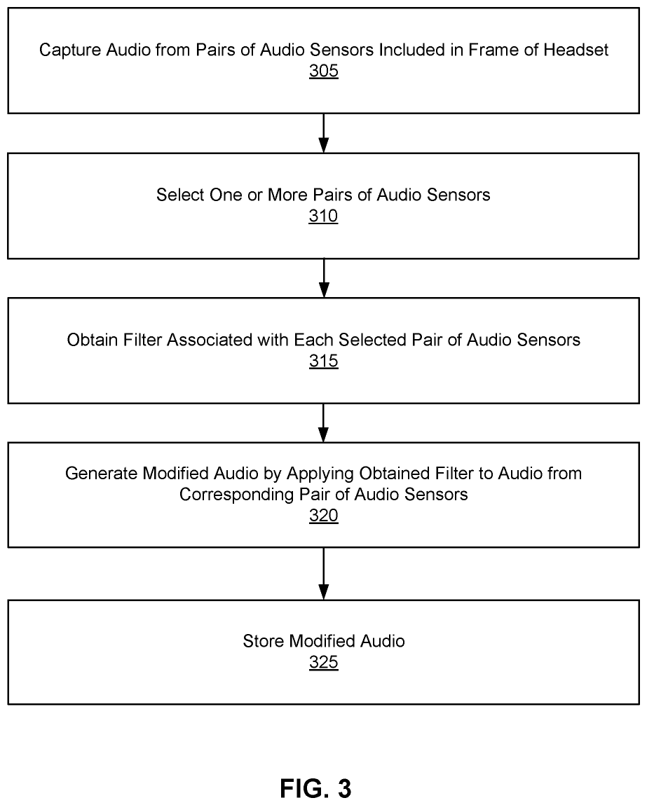

Different pairs of acoustic sensors are positioned different locations along the frame 110 in a direction perpendicular to the display elements 120 of the frame 110. Hence, different pairs of acoustic sensors have different distances from the display elements 120, causing different pairs of acoustic sensors to have different locations along a user's head. These different locations along the user's head cause different pairs of acoustic sensors to have different distances or positions relative to corresponding ears of the user when the user is wearing the frame 110. For example, acoustic sensor 182A has a minimum distance from the user's ear on the side of the frame 110 including acoustic sensor 180A, acoustic sensor 182A, acoustic sensor 184A, and acoustic sensor 186B, while acoustic sensor 182B has a minimum distance from the user's ear on the side of the frame 110 including acoustic sensor 180B, acoustic sensor 182B, acoustic sensor 184B, and acoustic sensor 186B. In other examples, a different pair of acoustic sensors are nearest to the user's ears. In various embodiments, a pair of acoustic sensors positioned nearest an ear canal of each ear of the user on the frame 110 acts as binaural microphones, as further described below in conjunction with FIGS. 3-7.

An acoustic sensor captures sounds emitted from one or more sound sources in the local area (e.g., a room). Each acoustic sensor is configured to detect sound and convert the detected sound into an electronic format (analog or digital). The acoustic sensors may be acoustic wave sensors, microphones, sound transducers, or similar sensors that are suitable for detecting sounds.

In some embodiments, the acoustic sensors may be placed on an exterior surface of the headset, placed on an interior surface of the headset, separate from the headset (e.g., part of some other device), or some combination thereof. The number and/or locations of acoustic sensors may be different from what is shown in FIG. 1. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset. For example, pairs of acoustic sensors are symmetrically positioned along opposite sides of the frame 110 to allow omnidirectional detection of sound in a local area including the frame 110, as further described below in conjunction with FIGS. 3-7.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

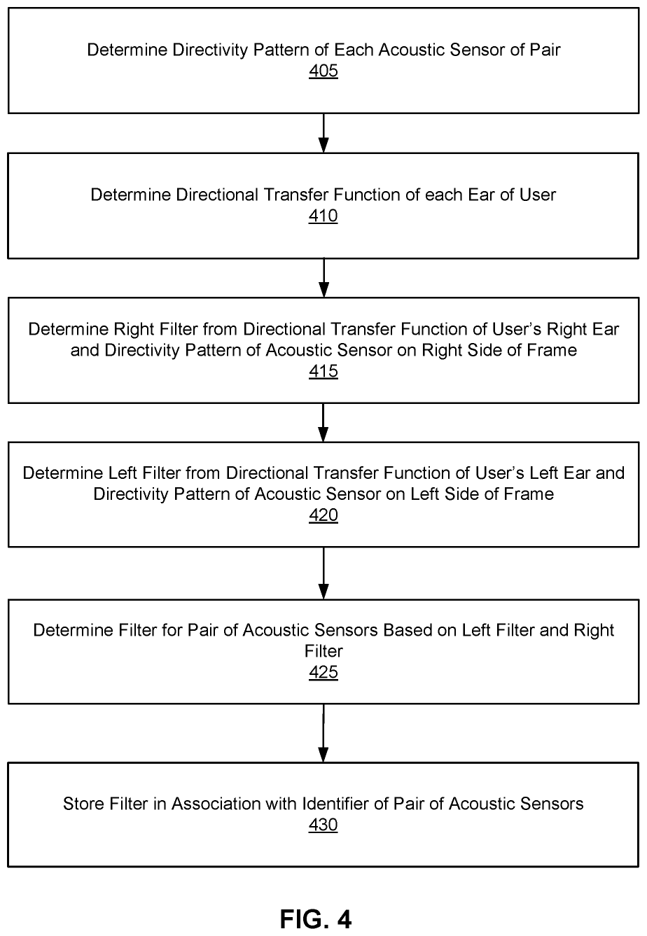

As further described below in conjunction with FIGS. 3-7, the audio controller 150 processes audio captured by one or more pairs of acoustic sensors to generate modified audio that has characteristics more similar to, or matching, audio captured at the user's ears. For example, the audio controller 150 selects a pair of acoustic sensors and retrieves one or more filters associated with the selected pair of acoustic sensors. In some embodiments, a filter associated with a selected pair of acoustic sensors minimizes differences between a directional transfer function of an ear of the user and a directivity pattern of an acoustic sensor of the selected pair. In some embodiments, the filter associated with the selected pair of acoustic sensors amplifies sound originating from certain directions relative to an acoustic sensor and attenuates sound originating from other directions relative to the acoustic sensor. In various embodiments, a filter associated with a selected pair of acoustic sensors applies weights to audio based on a frequency of the audio and a direction of the audio relative to the acoustic sensor. Hence, different weights are applied to different frequencies and to different orientations of audio relative to the acoustic sensor in some embodiments. As further described below in conjunction with FIGS. 3 and 4, the audio controller 150 determines a filter for each acoustic sensors of a pair based on differences between a directivity pattern for an acoustic sensor of the pair and the directivity pattern of the corresponding ear of the user and generates a single filter for the pair from the acoustic-sensor specific filters. This results in a single filter, or set of weights, applied to audio captured by both acoustic sensors of the pair of acoustic sensors. The audio controller 150 determines a filter for each pair of acoustic sensors (e.g., the pair of acoustic sensors 180A, 180B, the pair of acoustic sensors 182A, 182B, the pair of acoustic sensors 184A, 184B, the pair of acoustic sensors 186A, 186B, etc.). and stores a filter in association with an identifier of a corresponding pair of acoustic sensors.

Alternatively or additionally, the audio controller 150 includes a target frequency response for the user's ears and retrieves the directional transfer function for a user's ear. The target frequency response may take the form of a diffuse field response that represents the unweighted spatial average across all possible sound directions, or a weighted diffuse field response that may give more weight to particular directions, or a diffuse-field equalized response that represents a target frequency response that is normalized by either the diffuse field response or the weighted diffuse field response. In some embodiments, the target frequency response for the user's ear is determined through an initial configuration process when the frame 110 is constructed and is stored in the audio controller 150. Additionally, the audio controller 150 determines a target frequency response for each acoustic sensor of a pair. For each acoustic sensor of a pair (e.g., acoustic sensor 180A and acoustic sensor 180B), the audio controller determines a ratio of the target frequency response for the user's ear to a target frequency response for an acoustic sensor of the pair on a same side as the user's ear. The audio controller 150 determines a ratio for the pair of acoustic sensors based on the ratio of the target frequency response for one of the user's ears to a target frequency response for an acoustic sensor of the pair corresponding to the user's ear and the ratio of the target frequency response for the other ear of the user to a target frequency response for another acoustic sensor of the pair corresponding to the other ear of the user. For example, the audio controller 150 determines a left ratio of a target frequency response for a user's left ear to a target frequency response for an acoustic sensor on a left side of the frame 110 and determines a right ratio of a target frequency response for the user's right ear to a target frequency response for an acoustic sensor on a right side of the frame 110, with both acoustic sensors included in a pair. The audio controller 150 averages (or otherwise combines) the left ratio and the right ratio in some embodiments to determine a ratio for the pair of acoustic sensors, so a single ratio is stored for the pair of acoustic sensors. The ratio acts as a weight that the audio controller 150 applies to audio captured by acoustic sensors of the pair.

As further described below in conjunction with FIGS. 3-7, the audio controller 150 applies the filter for a pair of acoustic sensors to audio captured by acoustic sensors of the pair. Application of the filter allows the audio captured by the pair of acoustic sensors to more closely approximate perception of sound at the user's ears. When recording audio, the audio controller stores audio that has been modified by application of the filter for a selected pair of acoustic sensors that captured the audio for subsequent retrieval and playback.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

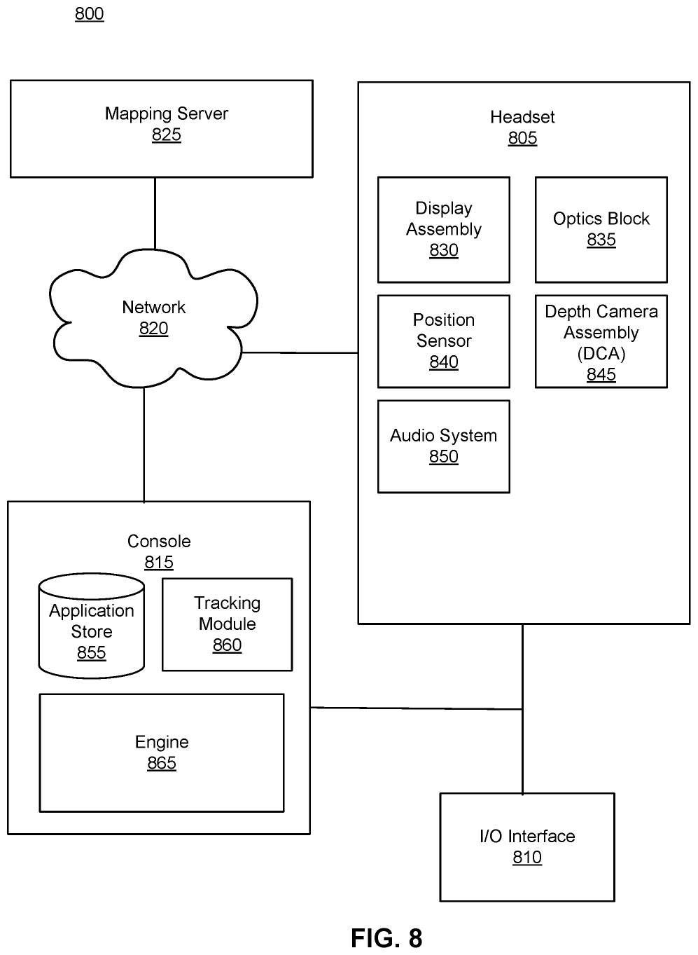

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 8.

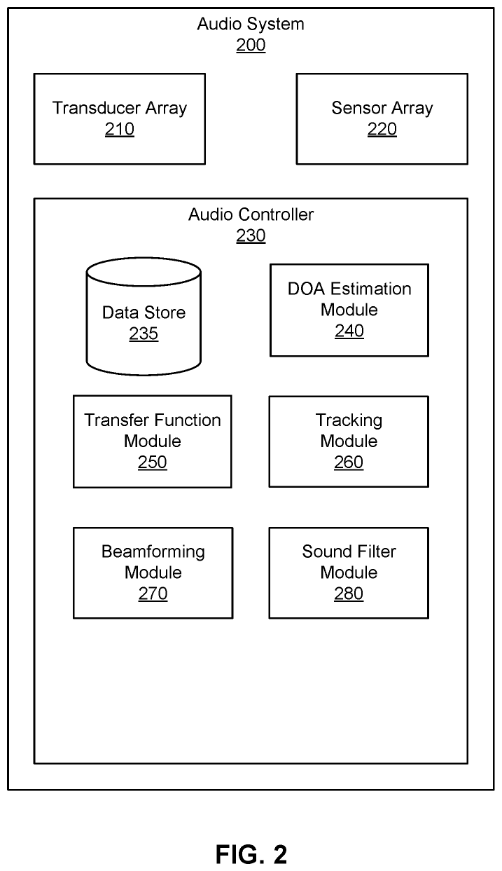

FIG. 2 is a block diagram of an audio system 200, in accordance with one or more embodiments. The audio system in FIG. 1 may be an embodiment of the audio system 200. The audio system 200 generates one or more acoustic transfer functions for a user. The audio system 200 may then use the one or more acoustic transfer functions to generate audio content for the user. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes a plurality of transducers. A transducer is a device that provides audio content. A transducer may be, e.g., a speaker (e.g., the speaker 160), a tissue transducer (e.g., the tissue transducer 170), some other device that provides audio content, or some combination thereof. A tissue transducer may be configured to function as a bone conduction transducer or a cartilage conduction transducer. The transducer array 210 may present audio content via air conduction (e.g., via one or more speakers), via bone conduction (via one or more bone conduction transducer), via cartilage conduction audio system (via one or more cartilage conduction transducers), or some combination thereof. In some embodiments, the transducer array 210 may include one or more transducers to cover different parts of a frequency range. For example, a piezoelectric transducer may be used to cover a first part of a frequency range and a moving coil transducer may be used to cover a second part of a frequency range.

The bone conduction transducers generate acoustic pressure waves by vibrating bone/tissue in the user's head. A bone conduction transducer may be coupled to a portion of a headset, and may be configured to be behind the auricle coupled to a portion of the user's skull. The bone conduction transducer receives vibration instructions from the audio controller 230, and vibrates a portion of the user's skull based on the received instructions. The vibrations from the bone conduction transducer generate a tissue-borne acoustic pressure wave that propagates toward the user's cochlea, bypassing the eardrum.

The cartilage conduction transducers generate acoustic pressure waves by vibrating one or more portions of the auricular cartilage of the ears of the user. A cartilage conduction transducer may be coupled to a portion of a headset, and may be configured to be coupled to one or more portions of the auricular cartilage of the ear. For example, the cartilage conduction transducer may couple to the back of an auricle of the ear of the user. The cartilage conduction transducer may be located anywhere along the auricular cartilage around the outer ear (e.g., the pinna, the tragus, some other portion of the auricular cartilage, or some combination thereof). Vibrating the one or more portions of auricular cartilage may generate: airborne acoustic pressure waves outside the ear canal; tissue born acoustic pressure waves that cause some portions of the ear canal to vibrate thereby generating an airborne acoustic pressure wave within the ear canal; or some combination thereof. The generated airborne acoustic pressure waves propagate down the ear canal toward the ear drum.

The transducer array 210 generates audio content in accordance with instructions from the audio controller 230. In some embodiments, the audio content is spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable device (e.g., the headset 100 or the headset 100). In alternate embodiments, the transducer array 210 may be a plurality of speakers that are separate from the wearable device (e.g., coupled to an external console).

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset (e.g., headset 100), on a user (e.g., in an ear canal of the user), on a neckband, or some combination thereof. As further described above in conjunction with FIG. 1, in various embodiments, the sensor array 220 includes pairs of acoustic sensors, with acoustic sensors of a pair positioned on opposite sides of the headset 100 and horizontally aligned with each other. An acoustic sensor may be, e.g., a microphone, a vibration sensor, an accelerometer, or any combination thereof. In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The audio controller 230 controls operation of the audio system 200. In the embodiment of FIG. 2, the audio controller 230 includes a data store 235, a DOA estimation module 240, a transfer function module 250, a tracking module 260, a beamforming module 270, and a sound filter module 280. The audio controller 230 may be located inside a headset, in some embodiments. Some embodiments of the audio controller 230 have different components than those described here. Similarly, functions can be distributed among the components in different manners than described here. For example, some functions of the controller may be performed external to the headset. The user may opt in to allow the audio controller 230 to transmit data captured by the headset to systems external to the headset, and the user may select privacy settings controlling access to any such data.

The data store 235 stores data for use by the audio system 200. Data in the data store 235 may include sounds recorded in the local area of the audio system 200, audio content, head-related transfer functions (HRTFs), transfer functions for one or more sensors, array transfer functions (ATFs) for one or more of the acoustic sensors, sound source locations, virtual model of local area, direction of arrival estimates, sound filters, and other data relevant for use by the audio system 200, or any combination thereof. In various embodiments, the data store 235 includes a directional transfer function for a user's ears. The directional transfer function may be determined from a configuration process prior to a user receiving the headset 100, with the directional transfer function for the user's ear stored in the data store 235 when the user receives the headset 100. The directional transfer function describes sensitivity to sound of the user's ear relative to a direction or an angle from which the sound arrives. The directivity pattern of the user may be determined through a configuration process, which may be performed before the user receives the headset 100. Additionally, in various embodiments, the data store 235 includes a diffuse field response of each ear of the user. A target frequency response for an ear of the user may be a generic target frequency response applicable to multiple users and stored in the data store 235 of the audio controller 230.

The user may opt-in to allow the data store 235 to record data captured by the audio system 200. In some embodiments, the audio system 200 may employ always on recording, in which the audio system 200 records all sounds captured by the audio system 200 in order to improve the experience for the user. The user may opt in or opt out to allow or prevent the audio system 200 from recording, storing, or transmitting the recorded data to other entities.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 220 received the direct-path audio signal. The determined angle may then be used to identify the DOA for the received input signal. Other algorithms not listed above may also be used alone or in combination with the above algorithms to determine DOA.

In some embodiments, the DOA estimation module 240 may also determine the DOA with respect to an absolute position of the audio system 200 within the local area. The position of the sensor array 220 may be received from an external system (e.g., some other component of a headset, an artificial reality console, a mapping server, a position sensor (e.g., the position sensor 190), etc.). The external system may create a virtual model of the local area, in which the local area and the position of the audio system 200 are mapped. The received position information may include a location and/or an orientation of some or all of the audio system 200 (e.g., of the sensor array 220). The DOA estimation module 240 may update the estimated DOA based on the received position information.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be array transfer functions (ATFs), head-related transfer functions (HRTFs), other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. And collectively the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, the ATFs of the sensor array 220 are personalized for each user of the audio system 200.

In some embodiments, the transfer function module 250 determines one or more HRTFs for a user of the audio system 200. The HRTF characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 250 may determine HRTFs for the user using a calibration process. In some embodiments, the transfer function module 250 may provide information about the user to a remote system. The user may adjust privacy settings to allow or prevent the transfer function module 250 from providing the information about the user to any remote systems. The remote system determines a set of HRTFs that are customized to the user using, e.g., machine learning, and provides the customized set of HRTFs to the audio system 200. In various embodiments, the transfer function module 250 determines a directional transfer function for each ear of the user from HRTFs for the user's ears determined during the calibration process.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond. The tracking module may compare the current DOA estimates with previous DOA estimates, and in response to a change in a DOA estimate for a sound source, the tracking module 260 may determine that the sound source moved. In some embodiments, the tracking module 260 may detect a change in location based on visual information received from the headset or some other external source. The tracking module 260 may track the movement of one or more sound sources over time. The tracking module 260 may store values for a number of sound sources and a location of each sound source at each point in time. In response to a change in a value of the number or locations of the sound sources, the tracking module 260 may determine that a sound source moved. The tracking module 260 may calculate an estimate of the localization variance. The localization variance may be used as a confidence level for each determination of a change in movement.

The beamforming module 270 is configured to process one or more ATFs to selectively emphasize sounds from sound sources within a certain area while de-emphasizing sounds from other areas. In analyzing sounds detected by the sensor array 220, the beamforming module 270 may combine information from different acoustic sensors to emphasize sound associated from a particular region of the local area while deemphasizing sound that is from outside of the region. The beamforming module 270 may isolate an audio signal associated with sound from a particular sound source from other sound sources in the local area based on, e.g., different DOA estimates from the DOA estimation module 240 and the tracking module 260. The beamforming module 270 may thus selectively analyze discrete sound sources in the local area. In some embodiments, the beamforming module 270 may enhance a signal from a sound source. For example, the beamforming module 270 may apply sound filters which eliminate signals above, below, or between certain frequencies. Signal enhancement acts to enhance sounds associated with a given identified sound source relative to other sounds detected by the sensor array 220.

The sound filter module 280 determines sound filters for the transducer array 210. In some embodiments, the sound filters cause the audio content to be spatialized, such that the audio content appears to originate from a target region. The sound filter module 280 may use HRTFs or acoustic parameters to generate the sound filters. The acoustic parameters describe acoustic properties of the local area. The acoustic parameters may include, e.g., a reverberation time, a reverberation level, a room impulse response, etc. In some embodiments, the sound filter module 280 calculates one or more of the acoustic parameters. In some embodiments, the sound filter module 280 requests the acoustic parameters from a mapping server (e.g., as described below with regard to FIG. 8).

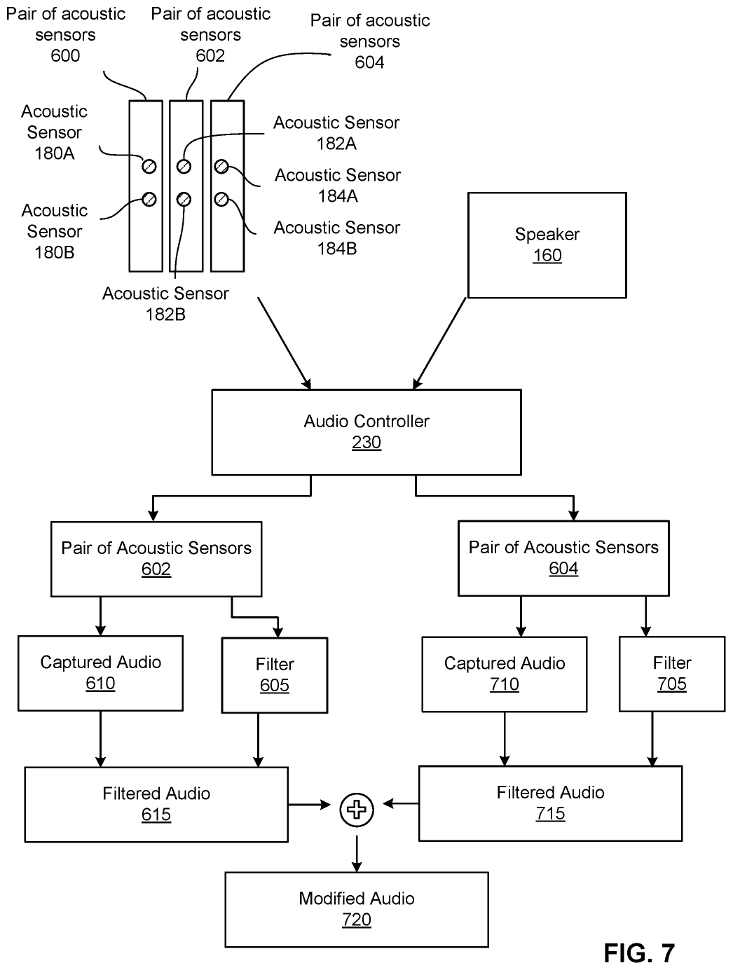

The sound filter module 280 provides the sound filters to the transducer array 210. In some embodiments, the sound filters may cause positive or negative amplification of sounds as a function of frequency. In various embodiments, the sound filter module 280 determines a filter, or a set of weights, for each of a plurality of pairs of acoustic sensors, such as those described above in conjunction with FIG. 1. For example, a frame 110 of a headset 100 includes multiple pairs of acoustic sensors, with a pair including a left acoustic sensor on a left side of the frame 110 and a right acoustic sensor on a right side of the frame 110. The left acoustic sensor and the right acoustic sensor are positioned so an axis perpendicular to the left acoustic sensor intersects the left acoustic sensor and the right acoustic sensor. As further described below in conjunction with FIGS. 3 and 4, the sound filter module 280 determines a filter, or a set of weights, for a pair of acoustic sensors based on a directional transfer function of the user's ear and directivity patterns of each acoustic sensor of the pair in some embodiments. Alternatively or additionally, the sound filter module 280 determines the filter, or the set of weights, for the pair of acoustic sensors based on target frequency responses for the user's ears and target frequency responses for each acoustic sensor of the pair. The sound filter module 280 applies the filter for a pair of acoustic sensors to audio captured by acoustic sensors of the pair, resulting in modified audio having increased similarity to audio that would have been heard by the user's ear. In some embodiments, the sound filter module 280 combines audio captured by multiple pairs of acoustic sensors when generating the modified audio. As further described below in conjunction with FIGS. 3 and 7, when combining audio from multiple pairs of acoustic sensors, the sound filter module 280 applies a filter corresponding to a pair of acoustic sensors to audio captured by the pair of acoustic sensors, generating filtered audio for each pair of acoustic sensors. The sound filter module 280 generates modified audio by combining filtered audio for each pair of acoustic sensors.

FIG. 3 is a flowchart of a method for capturing spatial audio by a headset 100, in accordance with one or more embodiments. The method shown in FIG. 3 may be performed by components of an audio system (e.g., audio system 200). Other entities may perform some or all of the steps in FIG. 3 in other embodiments. Embodiments may include different and/or additional steps, or perform the steps in different orders.

A headset 100, as further described above in conjunction with FIG. 1 includes one or more pairs of acoustic sensors. In various embodiments, the headset 100 includes multiple pairs of acoustic sensors. A pair of acoustic sensors includes an acoustic sensor on one side of a frame 110 of the headset 100 and an additional acoustic sensor on another side of the frame 110 that is opposite the side of the frame 110. Acoustic sensors of a pair are positioned along a horizontal axis that is perpendicular to an acoustic sensor of the pair and to an additional acoustic sensor of the pair. For example, the frame 110 has temples, or end pieces, configured to be on opposite sides of a user's head when the user wears the frame 110, and a pair of acoustic sensors includes an acoustic sensor on one temple and an additional acoustic sensor on the other temple, with the acoustic sensor and the additional acoustic sensor positioned along an axis perpendicular to the acoustic sensor and the additional acoustic sensor. In some embodiments, the frame 110 includes different pairs of acoustic sensors at different locations along the frame 110, as further described above in conjunction with FIG. 1.

One or more of the pairs of acoustic sensors capture 305 audio from a local area surrounding the frame 110. In various embodiments, multiple pairs of acoustic sensors capture 305 audio from the local area. For example, each pair of acoustic sensors on the frame 110 captures 305 audio from the local area surrounding the frame 110. In various embodiments, one or more pairs of acoustic sensors capture 305 data while an imaging device 130 of the frame captures video of the local area.

When a user wears the headset 100, acoustic sensors in different pairs have different positions relative to the user's ears. Referring to the headset 100 shown in FIG. 1, acoustic sensor 182A is nearest to one of the user's ears and acoustic sensor 182B is nearest to the other ear of the user when the headset 100 is worn. Acoustic sensors 180A, 184A, 186A, which are in other pairs of acoustic sensors, have relatively greater distances to the user's ear than acoustic sensor 182A, while acoustic sensors 180B, 184B, 186B have relatively greater distances to the user's ear than acoustic sensor 182B. The different distances between acoustic sensors and the user's ear results interaural cues between audio captured by acoustic sensors of a pair differing from interaural cues for audio captured by the user's ears. These differences in interaural cues result in audio captured by acoustic sensors of a pair sounding less realistic to the user when played back to the user.

To reduce differences between interaural cues of audio captured by acoustic sensors of a pair and interaural cues of audio captured by the user's ears, the audio controller 230 selects 310 one or more pairs of acoustic sensors. The audio controller 230 maintains one or more criteria for selecting one or more pairs of acoustic sensors in various embodiments. For example, the data store 235 of the audio controller 230 includes a default instruction to select a specific pair of acoustic sensors. As an example, the default instruction specifies selection of a pair of acoustic sensors having a specific location on the frame 110 (e.g., a pair of acoustic sensors located nearest a center of a temple along an axis perpendicular to a display element 120 of the frame). As another example, the audio controller 230 selects 310 one or more pairs of acoustic sensors that capture less than a threshold amount of audio played by a speaker 160 of the headset 100 or selects 310 one or more pairs of acoustic sensors with captured audio from the speaker 160 of the headset 100 having less than a threshold volume. In another example, the audio controller 230 selects 310 multiple pairs of acoustic sensors from which captured audio has less than a threshold amount of echo from audio played by the speaker 160; in various embodiments, selecting 310 pairs of acoustic sensors having less than the threshold amount of echo having increased distance from the speaker 160 to reduce an amount of audio from the speaker captured by acoustic sensors of the pair.

The audio controller 230 obtains 315 a filter associated with each selected pair of acoustic sensors. In various embodiments, the audio controller 230 maintains a filter associated with each pair of acoustic sensors. For example, a data store 235 maintains an identifier for each pair of acoustic sensors in a data store 235, with the data store 235 including a filter associated with an identifier of a pair of acoustic sensors. The audio controller 230 determines a filter for a selected pair of acoustic sensors based on directional transfer functions of the user's ears and directivity patterns of the acoustic sensors in the pair of acoustic sensors in some embodiments. In other embodiments, the audio controller 230 determines a filter for the selected pair of acoustic sensors based on target frequency responses for the user's ears and target frequency responses for acoustic sensors of the pair of acoustic sensors.

For example, FIG. 4 shows a flowchart of a method for determining a filter for a pair of acoustic sensors based on directional transfer functions of a user's ears and directivity patterns of acoustic sensors. The method shown in FIG. 4 may be performed by components of an audio system (e.g., audio system 200). Other entities may perform some or all of the steps in FIG. 4 in other embodiments. Embodiments may include different and/or additional steps, or perform the steps in different orders.

An audio controller 230 of an audio system 200 determines 405 a directivity pattern of each acoustic sensor of a pair. The directivity pattern of an acoustic sensor describes sensitivity of the acoustic sensor to sound relative to a direction or an angle from which the sound arrives. For example, the directivity pattern identifies different angles of sound relative to an axis perpendicular to a display element 120 of a frame 110 including the pair of acoustic sensors. In some embodiments, the audio controller 230 determines the directivity pattern of an acoustic sensor based on audio captured by the acoustic sensor from sources at different angles to the acoustic sensor. In some embodiments, the audio controller 230 determines 405 the directivity pattern of an acoustic sensor during a calibration or a configuration process. The audio controller 230 determines a directivity pattern for each acoustic sensor for multiple audio frequencies, such as audio having different frequencies within a range (e.g., audio having frequencies above a minimum frequency and below a maximum frequency). The audio controller 230 stores directivity patterns determined 405 for an acoustic sensor in association with an acoustic sensor in a data store 235 (or in a mapping server 825 accessible by the audio controller 230). For a pair of acoustic sensors, the audio controller 230 stores directivity patterns for each acoustic sensor of the pair. Different directivity patterns are determined for different frequencies in various embodiments, with frequency-specific directivity patterns stored in association with an acoustic sensor.

Additionally, the audio controller 230 determines 410 a directional transfer function for each ear of a user. In various embodiments, the audio controller 230 determines 410 the directional transfer function for an ear of the user based on a head related transfer function (HRTF) of the ear of the user. In some embodiments, the directional transfer function for an ear of the user is a HRTF of the ear of the user normalized by a diffuse field representation of the HRTF. The HRTF for the ear of the user may be a generic HRTF stored by the audio controller 230 in the data store 235 in some embodiments. In other embodiments, the HRTF of the ear of the user is determined from information about the user, such as one or more images of the user's head or of the user's ear. A HRTF of a user's ear may be determined during a calibration process, during which the directional transfer function of the user's ear is also determined. The audio controller 230 stores the directional transfer function for each ear of the user in association with an identifier of the user and an identifier of the user's ear corresponding to the directional transfer function in the data store 235.

For a pair of acoustic sensors, the audio controller 230 determines 415 a right filter comprising a set of weights applied to audio captured by an acoustic sensor on a right side of the frame 110 based on the directional transfer function of the user's right ear and the directivity pattern of the acoustic sensor on the right side of the frame 110. The right filter includes weights applied to sound originating from sources having different positions relative to the acoustic sensor, with the audio controller 230 determining weights for the right filter that minimize a difference between the directional transfer function of the user's right ear and the directivity pattern of the acoustic sensor of the pair on the right side of the frame 110. The audio controller 230 determines the weights for the right filter to minimize a difference between the directional transfer function of the user's right ear and the directivity pattern of the acoustic sensor on the right side of the frame 110 across a range of angles from which sound originates relative to the axis perpendicular to the display element 120 of the frame 110 in various embodiments. The audio controller 230 determines 415 a right filter for each frequency in a range of frequencies, such as a range of audible frequencies or frequencies between a minimum frequency and a maximum frequency in various embodiments.

In some embodiments, the audio controller 230 determines 415 multiple right filters, with a right filter minimizing a difference between the directional transfer function of the user's right ear and the directivity pattern of the acoustic sensor on the right side of the frame 110 and an alternative right filter directional transfer function of the user's right ear and the directivity pattern of the acoustic sensor on the right side of the frame 110 and amplifying audio originating from a range of positions relative to the acoustic sensor. For example, the alternative right filter increases an amplitude of sound originating from a specific range of positions relative to the acoustic sensor. As an example, the alternative right filter increases an amplitude of audio ipsilateral to the acoustic sensor and within a specific range of positions (e.g., between 45 and 60 degrees from the axis perpendicular to the display element 120 of the frame 110) relative to sound contralateral to the acoustic sensor. The alternative right filter allows originating from specific positions relative to the acoustic sensor on the right side of the frame 110 to be emphasized, while reducing the difference between the directional transfer function of the user's right ear and the directivity pattern of the acoustic sensor on the right side of the frame 110.

Similarly, the audio controller 230 determines 420 a left filter comprising a set of weights applied to audio captured by an acoustic sensor on a left side of the frame 110 based on the directional transfer function of the user's left ear and the directivity pattern of the acoustic sensor on the left side of the frame 110. The left filter is determined 420 includes weights applied to sound originating from sources having different positions relative to the acoustic sensor on the left side of the frame 110, with the audio controller 230 determining weights for the left filter that minimize a difference between the directional transfer function of the user's left ear and the directivity pattern of the acoustic sensor of the pair on the left side of the frame 110. The audio controller 230 determines the weights for the left filter to minimize a difference between the directional transfer function of the user's left ear and the directivity pattern of the acoustic sensor on the left side of the frame 110 across a range of angles from which sound originates relative to the axis perpendicular to the display element 120 of the frame 110 in various embodiments. The audio controller 230 determines 420 a left filter for each frequency in a range of frequencies, such as a range of audible frequencies or frequencies between a minimum frequency and a maximum frequency in various embodiments.

In some embodiments, the audio controller 230 determines 420 multiple left filters, with a left filter minimizing a difference between the directional transfer function of the user's left ear and the directivity pattern of the acoustic sensor on the left side of the frame 110 and an alternative left filter directional transfer function of the user's left ear and the directivity pattern of the acoustic sensor on the left side of the frame 110 and amplifying audio originating from a range of positions relative to the acoustic sensor. For example, the alternative left filter increases an amplitude of sound originating from a specific range of positions relative to the acoustic sensor. As an example, the alternative left filter increases an amplitude of audio ipsilateral to the acoustic sensor and within a specific range of positions (e.g., between 45 and 60 degrees from the axis perpendicular to the display element 120 of the frame 110) relative to sound contralateral to the acoustic sensor. The alternative left filter allows originating from specific positions relative to the acoustic sensor on the left side of the frame 110 to be emphasized, while reducing the difference between the directional transfer function of the user's left ear and the directivity pattern of the acoustic sensor on the left side of the frame 110.

For a pair of acoustic sensors, the audio controller 230 determines 415 one or more left filters for an acoustic sensor of the pair on the left side of the frame 110 and determines 420 one or more right filters for an additional acoustic sensor of the pair on the right side of the frame 110. From the left filters and the right filters, the audio controller 230 determines 425 a filter for the pair of acoustic sensors, with the filter applied to audio from both acoustic sensors of the pair. Determining a single filter that is applied to audio captured by both acoustic sensors of the pair prevents introduction of interaural or interchannel differences to the audio from application of different filters for each acoustic sensor of the pair that affects subsequent user perception of the captured audio. In various embodiments, the audio controller 230 determines 425 the filter for the pair of acoustic sensors as an average of the left filter and the right filter for the individual acoustic sensors of the pair. However, in other embodiments, the audio controller 230 determines 425 the filter for the pair of acoustic sensors through other combinations of the left filter and the right filter. In various embodiments, the audio controller 230 determines 425 a filter for the pair of acoustic sensors for a plurality of different frequencies, with the filter for the pair for a frequency determined 425 from a left filter for the frequency and a right filter for the frequency, resulting in multiple filters for the pair of acoustic sensors, with each filter associated with one or more frequencies. In embodiments where the audio controller 230 determines 415 an alternative right filter and determines 420 an alternative left filter, the audio controller 230 determines 425 an alternative filter for the pair of acoustic sensors as an average or other combination of the alternative right filter and the alternative left filter.

The audio controller 230 stores 430 the filter determined for the pair of acoustic sensors in association with an identifier of the pair of acoustic sensors. In various embodiments, the audio controller 230 stores 430 each filter determined for the pair of acoustic sensors in association with an identifier of the pair of acoustic sensors, allowing storage of filters for different frequencies or the filter and the alternative filter. Thus, in various embodiments, the audio controller 230 stores a set of filters each associated with one or more frequencies in association with a pair of acoustic sensors.

The audio controller 230 determines 425 and stores 430 one or more filters for each pair of acoustic sensors, with each determined filter stored in association with an identifier corresponding to a pair of acoustic sensors. For example, the audio controller 230 determines 425 one or more filters for a pair of acoustic sensors including acoustic sensor 180A and acoustic sensor 180B, determines 425 one or more filters for another pair of acoustic sensors including acoustic sensor 182A and acoustic sensor 182B, determines 425 one or more filters for a different pair of acoustic sensors including acoustic sensor 184A and acoustic sensor 184B, and determines 425 one or more filters for an additional pair of acoustic sensors including acoustic sensor 186A and acoustic sensor 186B. This allows the audio controller 230 to maintain filters for application to audio captured by different pairs of acoustic sensors included in a frame 110.

Maintaining filters for different pairs of acoustic sensors allows the audio controller 230 to account for different positions of pairs of acoustic sensors relative to the user's ears. This allows the audio controller 230 to differently modify audio captured by different pairs of acoustic sensors using a filter specific to a pair of acoustic sensors that captured audio.

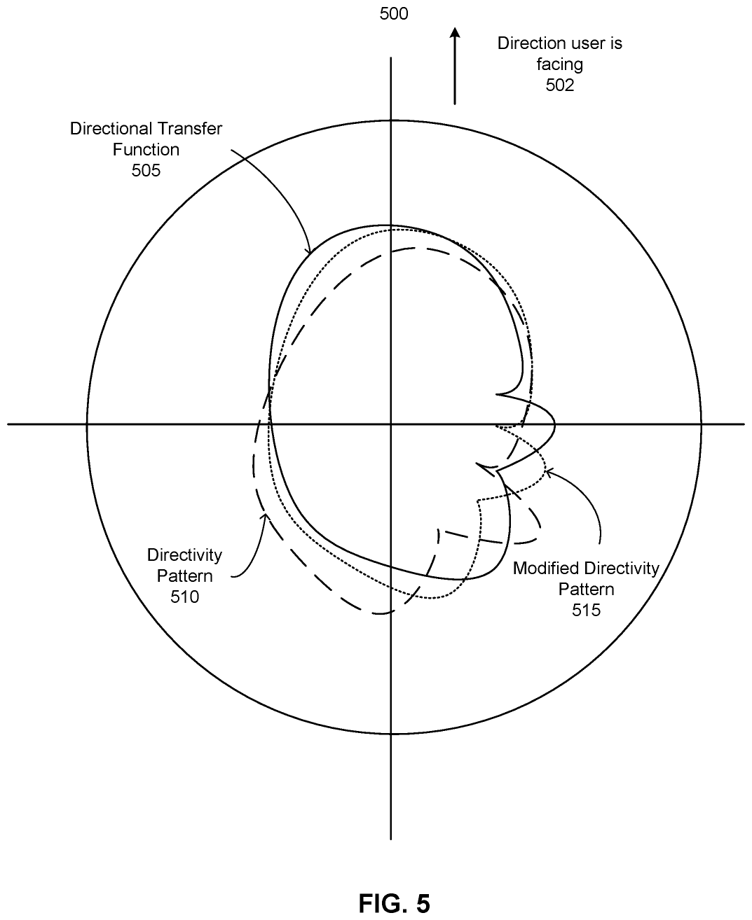

For purposes of illustration, FIG. 5 shows an example result of application of a filter determined for a pair of acoustic sensors to a directivity pattern of an acoustic sensor of the pair. In the example of FIG. 5, a directional transfer function 505 for a user's left ear is shown. The directional transfer function 505 represents the sensitivity of the user's left ear to sound originating from different angles relative to an axis 500 perpendicular to a display element 120 of a frame 110 including the pair of acoustic sensors. In the example of FIG. 5, direction 502 along the axis 500 corresponds to locations in front of a user wearing the frame 110, with directions of sound sources specified as angles relative to the axis 500.

FIG. 5 also depicts a directivity pattern 510 of an acoustic sensor of a pair. In the example of FIG. 5, the directivity pattern 510 is for an acoustic sensor of the pair on a left side of the frame 110. So the directivity pattern 510 is for an acoustic sensor ipsilateral to the user's left ear. As shown in FIG. 5, the directivity pattern 510 of the acoustic sensor is not aligned with the directional transfer function 505 for the user's left ear. The differences between the directivity pattern 510 of the acoustic sensor and the directional transfer function 505 are caused by the differing locations of user's ear and the acoustic sensor (e.g., the acoustic sensor being on a location of the frame 110 separated from the user's ear by a distance). The differences between the directivity pattern 510 of the acoustic sensor and the directional transfer function 505 cause interaural cues in audio captured by the acoustic sensor to differ from interaural cues present in the audio at the user's ear. These differences cause playback of audio captured by the acoustic sensor to sound differently than audio captured by the user's ear.

To mitigate differences in interaural cues between audio captured by a user's ear and audio captured by the acoustic sensor of the pair, the audio controller 230 applies a filter determined for the pair of acoustic sensors to audio captured by each acoustic sensor of the pair. Application of the filter to the audio results in a modified directivity pattern 515 for the acoustic sensor with reduced differences from the directional transfer function 505 than the directivity pattern 510. The filter includes different weights corresponding to different positions of sound sources relative to the acoustic sensor. In some embodiments, the filter attenuates audio originating from sources having certain positions relative to the acoustic sensor and amplifies audio originating from sources having other positions relative to the acoustic sensor. For example, the filter amplifies audio originating from a range of orientations within a user's field of view, while attenuating audio originating from orientations outside the user's field of view. Application of the filter to the captured audio results in the modified directivity pattern 515 of the acoustic sensor that more closely approximates the directional transfer function 505 of the user's ear. The increased similarity between the modified directivity pattern 515 and the directional transfer function 505 causes presentation of audio captured by the acoustic sensor to sound more similar to audio captured by the user's ear when played back to the user.

Referring back to FIG. 3, in other embodiments, the audio controller 230 determines one or more filters for a pair of acoustic sensors based on target frequency responses of the user's ears and target frequency responses of the acoustic sensors of the pair. In various embodiments, the audio controller 230 determines a left ratio of a target frequency response for a user's left ear and a target frequency response for an acoustic sensor of the selected pair on a left side of the frame 110. Similarly, the audio controller 230 determines a right ratio of a target frequency response for a user's right ear and a target frequency response for an additional sensor of the selected pair on a right side of the frame 110. From the left ratio and the right ratio, the audio controller determines 230 a filter for the pair of acoustic sensors. For example, the controller 230 determines a filter for the pair of acoustic sensors as an average of the left ratio and the right ratio, while in other embodiments, the controller 230 determines the filter for the pair of acoustic sensors through other combinations of the left ratio and the right ratio. Using target frequency responses to determine the filter for the pair of acoustic sensors allows the filter to apply the target frequency response for the user's ears to captured audio independent of relative direction between a source of captured audio and acoustic sensors of the pair. As further described above in conjunction with FIG. 4, the audio controller 230 determines a filter from target frequency responses for each of the user's ears and target frequency responses for each of the acoustic sensors of the pair for each pair of acoustic sensors included in the frame 110. In various embodiments, the audio controller 230 determines and stores filters for each pair of acoustic sensors based on target frequency responses for each of the user's ears and target frequency responses for each of the acoustic sensors of the pair, as well as filters based on directional transfer functions of the user's ears and directivity patterns of the acoustic sensors of the pair, as further described above in conjunction with FIG. 4. Further, the audio controller 230 may determine multiple filters for each pair of acoustic sensors, with each filter corresponding to different frequencies or frequency ranges.

From the filters stored in association with various pairs of acoustic sensors, the audio controller 230 obtains 315 a filter associated with the selected pair of acoustic sensors. In various embodiments, the audio controller 230 selects a stored filter associated with an identifier of the selected pair of acoustic sensors. The audio controller 230 may account for other information when obtaining 315 the filter associated with the selected pair of acoustic sensors in some embodiments. For example, the audio controller 230 retrieves a setting specifying an operating mode and obtains 315 a filter associated with an identifier of the selected pair of acoustic sensors and associated with the setting. For example, the setting has a first value for the audio controller 230 to obtain 315 a filter determined from target frequency responses, while the setting has a second value for the audio controller 230 to obtain 320 a filter determined from directional transfer functions and directivity patterns. In another example, the setting has a value for the audio controller 230 to obtain 315 a filter for the pair that amplifies audio having certain orientations relative to an axis perpendicular to the display element 120 of a frame 110.

The audio controller 230 generates 320 modified audio by applying the obtained filter to audio captured by the selected pair of acoustic sensors and stores 325 the modified audio. Application of the obtained filter modifies the captured audio so interaural cues between the user's left ear and the user's right ear are introduced or are emphasized in the modified audio. This causes the modified audio, when played back to the user, to sound as if the modified audio was captured at the user's ears, rather than at the position of the selected pair of acoustic capture devices.

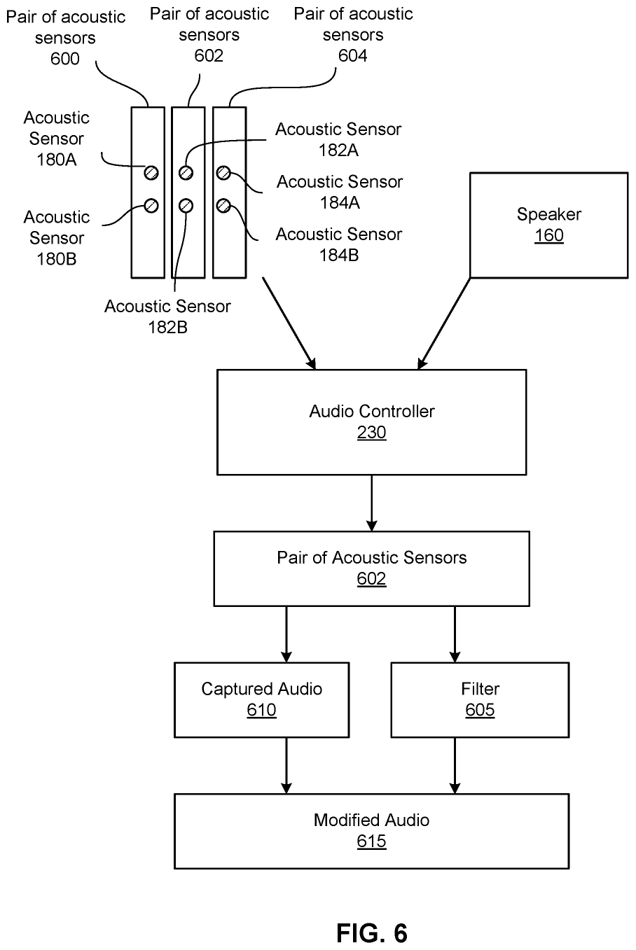

FIG. 6 is a process flow diagram of one embodiment of a method for capturing spatial audio by a headset 100. In the example of FIG. 6, an audio system 200, such as an audio system 200 included in a headset 100, includes a pair 600 of acoustic sensors 180A, 180B, a pair 602 of acoustic sensors 182A, 182B, and a pair 604 of acoustic sensors 184A, 184B. As further described above in conjunction with FIG. 1, acoustic sensors in a pair are positioned on opposite sides of frame 110 of the headset 100, with each sensor of a pair aligned with each other along a horizontal axis perpendicular to the sensors of the pair. For example, pair 602 includes acoustic sensor 182A on a right side of the frame 110 and acoustic sensor 182B on a left side of the frame 110, with acoustic sensor 182A and acoustic sensor 182B each along an axis that is perpendicular to acoustic sensor 182A and to acoustic sensor 182B. Hence, pair 600, pair 602, and pair 604 each include acoustic sensors that are on opposite sides of a user's head when the user wears the headset 100, with the acoustic sensors of a pair symmetrically positioned on opposite sides of a user's head when the headset 100 is worn. Acoustic sensors 180, 182, 184 each capture audio from a local area surrounding the audio system 200.

As further described above in conjunction with FIGS. 1 and 2, the audio system 200 also includes one or more speakers 160. Each speaker 160 is configured to output audio to the user. The audio controller 230 is coupled to the one or more speakers 160 and to each of pair 600, pair 602, and pair 604. The audio controller 230 selects at least one of pair 600, pair 602, and pair 604. In various embodiments, the audio controller 230 selects a pair based at least in part on audio output by the speakers 160. For example, the audio controller 230 selects a pair of acoustic sensors capturing a minimum amount of audio output from one or more speakers 160. In some embodiments, the audio controller 230 includes a default instruction for selecting a pair of acoustic sensors. For example, the default instruction stored by the audio controller 230 specifies selection of a pair of acoustic sensors having a location on the headset 100 most likely to be nearest to the user's ear. As an example, the default instruction specifies selection of a pair of acoustic sensors having a specific position on the frame in response to the one or more speakers 160 not playing audio. In the example of FIG. 6, the audio controller 230 selects pair 602 of acoustic sensors 182A, 182B. For example, acoustic sensor 182A and acoustic sensors 182B are positioned in a middle portion of a right temple and a left temple of a frame 110 of the headset, so the audio controller 230 selects pair 602 when no audio is output by the one or more speakers.

In the example of FIG. 6, the audio controller 230 selects a single pair of acoustic sensors, pair 602. To modify audio captured by acoustic sensor 182A and by acoustic sensor 182B of pair 602, the audio controller 230 obtains a filter 605 associated with pair 602. As further described above in conjunction with FIGS. 3 and 4, the audio controller 230 maintains one or more filters associated with each pair 600, 602, 604 and retrieves or obtains a filter 605 associated with the selected pair, pair 602 in the example of FIG. 6. For example, the audio controller 230 maintained different filters for a pair, with each filter corresponding to a different frequency or frequency range. The audio controller 230 applies the filter 605 to audio captured by the acoustic sensors of pair 602, generating modified audio 615 that is stored for subsequent playback to the user. The filter 605 is applied to audio captured by each acoustic sensor of pair 602, so a common filter is applied to audio captured by each acoustic sensor of the pair 602. As the filter 605 is determined based on characteristics of the user's ears, the filter 605 modifies the captured audio 610 so characteristics of the captured audio 610 are more similar to characteristics of audio captured by the user's ears. Hence, application of the filter 605 compensates for differences between the locations of the acoustic sensors 182A, 182B of the pair 602 and the locations of the user's ears by applying weights to various frequencies of the captured audio 610 based on a location of a source of the captured audio 610 relative to the location of an acoustic sensor 182 of pair 602. Thus, the modified audio 615 has characteristics (e.g., interaural cues) that more closely approximate the characteristics of audio captured by the user's ears, so the modified audio 615, when played back, sounds as if it were captured by the user's ears.

In some embodiments, the audio controller 230 selects multiple pairs of acoustic sensors from which spatial audio is generated. FIG. 7 is a process flow diagram of one embodiment of a method for capturing spatial audio by a headset 100 from multiple pairs of acoustic sensors. In the example of FIG. 7, an audio system 200, such as an audio system 200 included in a headset 100, includes pair 600 of acoustic sensors 180A, 180B, pair 602 of acoustic sensors 182A, 182B, and pair 604 of acoustic sensors 184A, 184B. As further described above in conjunction with FIGS. 1, 2, and 6, each pair includes an acoustic sensor on one side of a frame 110 of the headset 100 and an additional acoustic sensor on an opposite side of the frame 110, with the acoustic sensor and the additional acoustic sensor aligned along a horizontal axis perpendicular to both the acoustic sensor and the additional acoustic sensor.

As further described above in conjunction with FIG. 6, the audio controller 230 selects one or more pairs. In the example shown by FIG. 7, the audio controller 230 selects pair 602 and pair 604. For example, the audio controller 230 selects one or more pairs of acoustic sensors that capture less than a threshold amount of audio played by a speaker 160 of the headset 100 or selects one or more pairs of acoustic sensors with captured audio from the speaker 160 of the headset 100 having less than a threshold volume. In another example, the audio controller 230 selects multiple pairs of acoustic sensors from which captured audio has less than a threshold amount of echo from audio played by the speaker 160; in various embodiments, selecting pairs of acoustic sensors having less than the threshold amount of echo having increased distance from the speaker 160 to reduce an amount of audio from the speaker captured by acoustic sensors of the pair. In various embodiments, the audio controller 230 selects multiple pairs of acoustic sensors in response to determining the speaker 160 outputs audio.

The audio controller 230 selects a filter associated with each selected pair, as further described above in conjunction with FIGS. 3 and 6. In the example of FIG. 7, the audio controller 230 selects filter 605 for pair 602 and selects filter 705 for pair 604. In various embodiments, the filter 605 includes multiple filters for different frequencies, and filter 705 includes multiple filters for different frequencies. The audio controller 230 applies filter 605 to audio 610 captured by acoustic sensors 182A, 182B of pair 602 to generate filtered audio 615. Similarly, the audio controller 230 applies filter 705 to audio 710 captured by acoustic sensors 184A, 184B of pair 604 to generate filtered audio 715.

The audio controller 230 combines filtered audio 615 and filtered audio 715 to generate modified audio 720, which is stored for subsequent playback to the user. In some embodiments, the audio controller 230 performs broadband mixing to combine filtered audio 615 and filtered audio 715. However, in other embodiments, the audio controller 230 performs frequency-dependent mixing of filtered audio 615 and filtered audio 715, resulting in different combinations of filtered audio 615 and filtered audio 715 for different frequency subbands. As the pairs of acoustic sensors were selected to reduce audio from a speaker 160 of the headset 100 included in the captured audio 610, 710, the modified audio 720 reduces (or eliminates) echo from the speaker 160 introduced when the selected pairs 602, 604 captured audio, allowing the modified audio 720 to more closely approximate audio captured at the user's ears and to minimize echo from audio output from speakers 160 of the headset 100 to emphasize audio from the local area surrounding the headset 100.

FIG. 8 is a system 800 that includes a headset 805, in accordance with one or more embodiments. In some embodiments, the headset 805 may be the headset 100 of FIG. 1. The system 800 may operate in an artificial reality environment (e.g., a virtual reality environment, an augmented reality environment, a mixed reality environment, or some combination thereof). The system 800 shown by FIG. 8 includes the headset 805, an input/output (I/O) interface 810 that is coupled to a console 815, the network 820, and the mapping server 825. While FIG. 8 shows an example system 800 including one headset 805 and one I/O interface 810, in other embodiments any number of these components may be included in the system 800. For example, there may be multiple headsets each having an associated I/O interface 810, with each headset and I/O interface 810 communicating with the console 815. In alternative configurations, different and/or additional components may be included in the system 800. Additionally, functionality described in conjunction with one or more of the components shown in FIG. 8 may be distributed among the components in a different manner than described in conjunction with FIG. 8 in some embodiments. For example, some or all of the functionality of the console 815 may be provided by the headset 805.

The headset 805 includes the display assembly 830, an optics block 835, one or more position sensors 840, and the DCA 845. Some embodiments of headset 805 have different components than those described in conjunction with FIG. 8. Additionally, the functionality provided by various components described in conjunction with FIG. 8 may be differently distributed among the components of the headset 805 in other embodiments, or be captured in separate assemblies remote from the headset 805.

The display assembly 830 displays content to the user in accordance with data received from the console 815. The display assembly 830 displays the content using one or more display elements (e.g., the display elements 120). A display element may be, e.g., an electronic display. In various embodiments, the display assembly 830 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 835.

The optics block 835 may magnify image light received from the electronic display, corrects optical errors associated with the image light, and presents the corrected image light to one or both eyeboxes of the headset 805. In various embodiments, the optics block 835 includes one or more optical elements. Example optical elements included in the optics block 835 include: an aperture, a Fresnel lens, a convex lens, a concave lens, a filter, a reflecting surface, or any other suitable optical element that affects image light. Moreover, the optics block 835 may include combinations of different optical elements. In some embodiments, one or more of the optical elements in the optics block 835 may have one or more coatings, such as partially reflective or anti-reflective coatings.

Magnification and focusing of the image light by the optics block 835 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 835 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 835 corrects the distortion when it receives image light from the electronic display generated based on the content.

The position sensor 840 is an electronic device that generates data indicating a position of the headset 805. The position sensor 840 generates one or more measurement signals in response to motion of the headset 805. The position sensor 190 is an embodiment of the position sensor 840. Examples of a position sensor 840 include: one or more IMUs, one or more accelerometers, one or more gyroscopes, one or more magnetometers, another suitable type of sensor that detects motion, or some combination thereof. The position sensor 840 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 805 from the sampled data. For example, the IMU integrates the measurement signals received from the accelerometers over time to estimate a velocity vector and integrates the velocity vector over time to determine an estimated position of a reference point on the headset 805. The reference point is a point that may be used to describe the position of the headset 805. While the reference point may generally be defined as a point in space, however, in practice the reference point is defined as a point within the headset 805.

The DCA 845 generates depth information for a portion of the local area. The DCA includes one or more imaging devices and a DCA controller. The DCA 845 may also include an illuminator. Operation and structure of the DCA 845 is described above with regard to FIG. 1.

The audio system 850 provides audio content to a user of the headset 805. The audio system 850 is substantially the same as the audio system 200 described above. The audio system 850 may comprise one or acoustic sensors, one or more transducers, and an audio controller. The audio system 850 may provide spatialized audio content to the user. In some embodiments, the audio system 850 may request acoustic parameters from the mapping server 825 over the network 820. The acoustic parameters describe one or more acoustic properties (e.g., room impulse response, a reverberation time, a reverberation level, etc.) of the local area. The audio system 850 may provide information describing at least a portion of the local area from e.g., the DCA 845 and/or location information for the headset 805 from the position sensor 840. The audio system 850 may generate one or more sound filters using one or more of the acoustic parameters received from the mapping server 825, and use the sound filters to provide audio content to the user.

As further described above in conjunction with FIGS. 1-7 the audio system 850 includes a plurality of pairs of acoustic sensors symmetrically positioned on opposite sides of the headset 805. The audio system 850 generates and stores a filter for each pair of acoustic sensors. When recording audio, the audio system 850 selects one or more pairs of acoustic sensors and applies a filter corresponding to a pair of acoustic sensors to audio captured by the pair of acoustic sensors. As further described above in conjunction with FIGS. 2-7, applying a filter associated with a pair of acoustic sensors to audio captured by the pair of acoustic sensors results in modified audio having characteristics more similar to audio captured by the user's ears than by the acoustic sensors of the pair. When multiple pairs of acoustic sensors are combined, the audio system 850 combines the filtered audio from each pair after application of a corresponding filter to generate the modified audio.

The I/O interface 810 is a device that allows a user to send action requests and receive responses from the console 815. An action request is a request to perform a particular action. For example, an action request may be an instruction to start or end capture of image or video data, or an instruction to perform a particular action within an application. The I/O interface 810 may include one or more input devices. Example input devices include: a keyboard, a mouse, a game controller, or any other suitable device for receiving action requests and communicating the action requests to the console 815. An action request received by the I/O interface 810 is communicated to the console 815, which performs an action corresponding to the action request. In some embodiments, the I/O interface 810 includes an IMU that captures calibration data indicating an estimated position of the I/O interface 810 relative to an initial position of the I/O interface 810. In some embodiments, the I/O interface 810 may provide haptic feedback to the user in accordance with instructions received from the console 815. For example, haptic feedback is provided when an action request is received, or the console 815 communicates instructions to the I/O interface 810 causing the I/O interface 810 to generate haptic feedback when the console 815 performs an action.

The console 815 provides content to the headset 805 for processing in accordance with information received from one or more of: the DCA 845, the headset 805, and the I/O interface 810. In the example shown in FIG. 8, the console 815 includes an application store 855, a tracking module 860, and an engine 865. Some embodiments of the console 815 have different modules or components than those described in conjunction with FIG. 8. Similarly, the functions further described below may be distributed among components of the console 815 in a different manner than described in conjunction with FIG. 8. In some embodiments, the functionality discussed herein with respect to the console 815 may be implemented in the headset 805, or a remote system.

The application store 855 stores one or more applications for execution by the console 815. An application is a group of instructions, that when executed by a processor, generates content for presentation to the user. Content generated by an application may be in response to inputs received from the user via movement of the headset 805 or the I/O interface 810. Examples of applications include: gaming applications, conferencing applications, video playback applications, or other suitable applications.

The tracking module 860 tracks movements of the headset 805 or of the I/O interface 810 using information from the DCA 845, the one or more position sensors 840, or some combination thereof. For example, the tracking module 860 determines a position of a reference point of the headset 805 in a mapping of a local area based on information from the headset 805. The tracking module 860 may also determine positions of an object or virtual object. Additionally, in some embodiments, the tracking module 860 may use portions of data indicating a position of the headset 805 from the position sensor 840 as well as representations of the local area from the DCA 845 to predict a future location of the headset 805. The tracking module 860 provides the estimated or predicted future position of the headset 805 or the I/O interface 810 to the engine 865.

The engine 865 executes applications and receives position information, acceleration information, velocity information, predicted future positions, or some combination thereof, of the headset 805 from the tracking module 860. Based on the received information, the engine 865 determines content to provide to the headset 805 for presentation to the user. For example, if the received information indicates that the user has looked to the left, the engine 865 generates content for the headset 805 that mirrors the user's movement in a virtual local area or in a local area augmenting the local area with additional content. Additionally, the engine 865 performs an action within an application executing on the console 815 in response to an action request received from the I/O interface 810 and provides feedback to the user that the action was performed. The provided feedback may be visual or audible feedback via the headset 805 or haptic feedback via the I/O interface 810.

The network 820 couples the headset 805 and/or the console 815 to the mapping server 825. The network 820 may include any combination of local area and/or wide area networks using both wireless and/or wired communication systems. For example, the network 820 may include the Internet, as well as mobile telephone networks. In one embodiment, the network 820 uses standard communications technologies and/or protocols. Hence, the network 820 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 820 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 820 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 825 may include a database that stores a virtual model describing a plurality of spaces, wherein one location in the virtual model corresponds to a current configuration of a local area of the headset 805. The mapping server 825 receives, from the headset 805 via the network 820, information describing at least a portion of the local area and/or location information for the local area. The user may adjust privacy settings to allow or prevent the headset 805 from transmitting information to the mapping server 825. The mapping server 825 determines, based on the received information and/or location information, a location in the virtual model that is associated with the local area of the headset 805. The mapping server 825 determines (e.g., retrieves) one or more acoustic parameters associated with the local area, based in part on the determined location in the virtual model and any acoustic parameters associated with the determined location. The mapping server 825 may transmit the location of the local area and any values of acoustic parameters associated with the local area to the headset 805.

One or more components of system 800 may contain a privacy module that stores one or more privacy settings for user data elements. The user data elements describe the user or the headset 805. For example, the user data elements may describe a physical characteristic of the user, an action performed by the user, a location of the user of the headset 805, a location of the headset 805, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 800 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A system comprising:
one or more pairs of acoustic sensors positioned on a frame, a pair of acoustic sensors including acoustic sensors on opposite sides of the frame and aligned along an axis perpendicular to the acoustic sensors, each acoustic sensor configured to capture audio; and
an audio controller configured to:
select one or more pairs of acoustic sensors;
obtain a filter associated with a selected pair of acoustic sensors;
generate modified audio by applying the filter to the audio captured by each acoustic sensor of the selected pair of acoustic sensors; and
store the modified audio.

2. The system of claim 1, wherein the audio controller is further configured to:
retrieve a filter determined based on a left ratio of a target frequency response for a user's left ear and a target frequency response for an acoustic sensor of the selected pair and based on a right ratio of a target frequency response for a user's right ear and a target frequency response for an additional sensor of the selected pair.

3. The system of claim 2, wherein the filter comprises an average of the left ratio and the right ratio.

4. The system of claim 1, wherein the audio controller is further configured to:
retrieve a filter determined based on a directivity pattern of audio captured by an acoustic sensor of the selected pair, a directivity pattern of audio captured by an additional acoustic sensor of the pair, a directional transfer function of a user's left ear, and a directional transfer function of a user's right ear.

5. The system of claim 4, wherein the audio controller is further configured to:
generate a left filter that minimizes a difference between the directivity pattern of audio captured by the acoustic sensor of the selected pair and the directional transfer function of the user's left ear;
generate a right filter that minimizes a difference between the directivity pattern of audio captured by the additional acoustic sensor of the selected pair and the directional transfer function of the user's left ear; and
determine the filter based on the left filter and the right filter.

6. The system of claim 5, wherein the audio controller is further configured to:
determine the filter as an average of the left filter and the right filter.

7. The system of claim 4, wherein the filter is configured to attenuate audio originating from sources having certain positions relative to the acoustic sensor or to the additional acoustic sensor and amplify audio originating from sources having other positions relative to the acoustic sensor or relative to the additional acoustic sensor.

8. The system of claim 1, wherein the audio controller is further configured to:
obtain additional audio captured by an additional selected pair of acoustic sensors, the additional selected pair of acoustic sensors having a different location on the frame than the pair of acoustic sensors;
generate filtered audio by applying the filter to the audio captured by each acoustic sensor of the pair;
generate additional filtered audio by applying an additional filter associated with the additional pair of acoustic sensors to the additional audio; and
generate the modified audio by combining the filtered audio and the additional filtered audio.

9. The system of claim 1, wherein the frame comprises a left temple and a right temple, and each pair of acoustic sensors includes an acoustic sensor on the left temple and an additional acoustic sensor on the right temple.

10. A method comprising:
capturing audio one or more pairs of acoustic sensors positioned on a frame, a pair of acoustic sensors including acoustic sensors on opposite sides of the frame and aligned along an axis perpendicular to the acoustic sensors;
selecting one or more pairs of acoustic sensors;
obtaining a filter associated with a selected pair of acoustic sensors;
generating modified audio by applying the filter to the audio captured by each acoustic sensor of the selected pair of acoustic sensors; and
storing the modified audio.

11. The method of claim 10, wherein obtaining the filter associated with the pair of acoustic sensors comprises:
Retrieving a filter determined based on a left ratio of a target frequency response for a user's left ear and a target frequency response for an acoustic sensor of the selected pair and based on a right ratio of a target frequency response for a user's right ear and a target frequency response for an additional sensor of the selected pair.

12. The method of claim 11, wherein the filter comprises an average of the left ratio and the right ratio.

13. The method of claim 10, wherein obtaining the filter associated with the pair of acoustic sensors comprises:
retrieving a filter determined based on a directivity pattern of audio captured by an acoustic sensor of the selected pair, a directivity pattern of audio captured by an additional acoustic sensor of the pair, a directional transfer function of a user's left ear, and a directional transfer function of a user's right ear.

14. The method of claim 13, wherein the filter is determined by:
generating a left filter that minimizes a difference between the directivity pattern of audio captured by the acoustic sensor of the selected pair and the directional transfer function of the user's left ear;
generating a right filter that minimizes a difference between the directivity pattern of audio captured by the additional acoustic sensor of the selected pair and the directional transfer function of the user's left ear; and
determining the filter based on the left filter and the right filter.

15. The method of claim 14, wherein determining the filter based on the left filter and the right filter comprises:
determining the filter as an average of the left filter and the right filter.

16. The method of claim 13, wherein the filter attenuates audio originating from sources having certain positions relative to the acoustic sensor or to the additional acoustic sensor and amplifies audio originating from sources having other positions relative to the acoustic sensor or relative to the additional acoustic sensor.

17. The method of claim 10, further comprising:
obtaining additional audio captured by an additional selected pair of acoustic sensors, the additional selected pair of acoustic sensors having a different location on the frame than the pair of acoustic sensors;
generating filtered audio by applying the filter to the audio captured by each acoustic sensor of the pair;
generating additional filtered audio by applying an additional filter associated with the additional pair of acoustic sensors to the additional audio; and
generating the modified audio by combining the filtered audio and the additional filtered audio.

18. A headset comprising:
a frame;
one or more display elements coupled to the frame, each display element configured to generate image light;
one or more pairs of acoustic sensors positioned on the frame, a pair of acoustic sensors including acoustic sensors on opposite sides of the frame and aligned along an axis perpendicular to the acoustic sensors, each acoustic sensor configured to capture audio; and
an audio controller, the audio controller including a processor and a non-transitory computer readable storage medium having instructions encoded thereon that, when executed by the processor, cause the audio controller to:
select one or more pairs of acoustic sensors;
obtain a filter associated with a selected pair of acoustic sensors;
generate modified audio by applying the filter to the audio captured by each acoustic sensor of the selected pair of acoustic sensors; and
store the modified audio.

19. The headset of claim 18, wherein the frame comprises a left temple and a right temple, and each pair of acoustic sensors includes an acoustic sensor on the left temple and an additional acoustic sensor on the right temple.

20. The headset of claim 18, wherein the non-transitory computer readable storage medium having instructions encoded thereon that, when executed by the processor, cause the audio controller to:
obtain additional audio captured by an additional selected pair of acoustic sensors, the additional selected pair of acoustic sensors having a different location on the frame than the pair of acoustic sensors;
generate filtered audio by applying the filter to the audio captured by each acoustic sensor of the pair;
generate additional filtered audio by applying an additional filter associated with the additional pair of acoustic sensors to the additional audio; and
generate the modified audio by combining the filtered audio and the additional filtered audio.
